(19) United States
(12) Patent Application Publication
(10) Pub. No.: US 2018/0143469 A1
(43) Pub. Date: May 24, 2018

(54) QUANTUM DOT FILM AND BACKLIGHT MODULE

(71) Applicant: Wuhan China Star Optoelectronics Technology Co., Ltd., Wuhan (CN)

(72) Inventors: Hongqing CUI, Wuhan (CN); Guowei ZHA, Wuhan (CN)

(21) Appl. No.: 15/329,287

(22) PCT Filed: Dec. 23, 2016
(86) PCT No.: PCT/CN2016/111640

§ 371 Date: Jan. 26, 2017

(30) Foreign Application Priority Data
Nov. 24, 2016 (CN) 201611052211.5

(51) Int. Cl. G02F 1/1335; G02F 1/017

(52) U.S. Cl. CPC G02F 1/1336; G02F 2001/01791; G02F 2001/133614; G02F 1/017

(57) ABSTRACT

A quantum dot film and a backlight module are provided herein. The quantum dot film includes a quantum light-emitting layer, a dielectric layer, and a metal layer. The quantum light-emitting layer includes a plurality of quantum rods orientated along a same direction. The metal layer includes a plurality of metal lines disposed at intervals. The metal lines have a first major axis. The quantum rods have a second major axis. An angle between an extending line of the first major axis and an extending line of the second major axis is within a predetermined angular range.

### TECHNICAL FIELD OF THE DISCLOSURE

The present invention relates to a liquid crystal display technology, and more particularly, to a quantum dot film and a backlight module.

### BACKGROUND OF THE DISCLOSURE

Currently, a brightness enhancement film is required in using a quantum dot film (QD film) to carry out extended color gamut and high light transmittance. As to the light paths, light from a blue light source coupled to a light guiding plate enters the light guiding pate and is emitted with blue light therefrom, the blue light is collimated using a prism film and then passes through a quantum dot film located above the prism film, the blue light is then excited to form red and green light within a narrow band, and the disordered polarization of them is transformed into a same linear polarization direction by a polarization transformation brightness enhancement film. This polarization direction is parallel to the transmittance axis of a polarization sheet at a light entrance side of a liquid crystal cell, thereby greatly increasing utilization of the backlight.

However, design difficulty is existing in such a structure. For a quantum dot film with a well-designed spectrum distribution, a part of light rays in some polarization directions will be reflected back to the quantum dot film after passing through the polarization transformation brightness enhancement film. As a result, the quantum dot film is excited again. Therefore, the ratio and exited red and green light is higher than expectation and this causes color deviation appeared on the entire display.

In addition, the energy of green light is apparently higher than that of red light. Thus, green light can be used to excite to bright about red light. After passing through a reflection-type brightness enhancement film structure, the green light in a polarization direction inconsistent with the transmittance axis of the brightness enhancement film will be reflected back to the quantum dot film and pass through it, and therefore red quantum dots are excited to irradiate light rays. The blue light excites green quantum dots and the green light excites red quantum dots. Therefore, energy loss is caused after two times of energy transformation. The energy loss is particularly serious in exciting the red quantum dots by the long-wavelength green light. This causes the problems of energy loss and color deviation easily occurred in the existing quantum dot film.

Therefore, there is a need to provide a quantum dot film and a backlight module for solving the problems in the existing skills.

### SUMMARY OF THE DISCLOSURE

The objective of the present invention is to provide a quantum dot film and a backlight module for solving the problems of energy loss and color deviation easily caused in the existing quantum dot film.

To solve above technical problems, the present invention provides a quantum dot film, comprising: a quantum light-emitting layer comprising a plurality of quantum rods orientated along a same direction, particle sizes of the quantum rods being ranged from 1 to 10 nanometers; a dielectric layer located on the quantum light-emitting layer; and a metal layer located on the dielectric layer, the metal layer comprising a plurality of metal lines disposed at intervals, wherein the metal lines have a first major axis, the quantum rods have a second major axis, and an extending line of the first major axis is substantially perpendicular to an extending line of the second major axis.

In the quantum dot film of the present invention, a distance between centers of two adjacent metal lines is ranged from 20 to 500 nanometers.

In the quantum dot film of the present invention, a ratio of a width of the metal lines to a central pitch is ranged from 0.1 to 0.9, where the central pitch is a distance between centers of two adjacent metal lines.

In the quantum dot film of the present invention, a thickness of the metal lines is ranged from 10 to 500 nanometers.

In the quantum dot film of the present invention, a material of the dielectric layer comprises at least of SiO₂, SiO, MgO, Si₃N₄, TiO₂, and Ta₂O₅.

In the quantum dot film of the present invention, a material of the metal layer comprises at least of Al, Ag, and Au.

In the quantum dot film of the present invention, the quantum dot film further comprises a first separation layer and a second separation layer, the first separation layer is located below the quantum light-emitting layer, and the second separation layer is located between the quantum light-emitting layer and the dielectric layer.

The present invention further provides a backlight module comprising a light guiding plate and a quantum dot film, the quantum dot film comprising: a quantum light-emitting layer comprising a plurality of quantum rods orientated along a same direction; a dielectric layer located on the quantum light-emitting layer; and a metal layer located on the dielectric layer, the metal layer comprising a plurality of metal lines disposed at intervals, wherein the metal lines have a first major axis, the quantum rods have a second major axis, and an angle between an extending line of the first major axis and an extending line of the second major axis is within a predetermined angular range.

In the backlight module of the present invention, the extending line of the first major axis is substantially perpendicular to the extending line of the second major axis.

In the backlight module of the present invention, particle sizes of the quantum rods are ranged from 1 to 10 nanometers.

In the backlight module of the present invention, a distance between centers of two adjacent metal lines is ranged from 20 to 500 nanometers.

In the backlight module of the present invention, a ratio of a width of the metal lines to a central pitch is ranged from 0.1 to 0.9, where the central pitch is a distance between centers of two adjacent metal lines.

In the backlight module of the present invention, a thickness of the metal lines is ranged from 10 to 500 nanometers.

In the backlight module of the present invention, a material of the dielectric layer comprises at least of SiO₂, SiO, MgO, Si₃N₄, TiO₂, and Ta₂O₅.

In the backlight module of the present invention, a material of the metal layer comprises at least of Al, Ag, and Au.

In the backlight module of the present invention, the quantum dot film further comprises a first separation layer and a second separation layer, the first separation layer is located below the quantum light-emitting layer, and the second separation layer is located between the quantum light-emitting layer and the dielectric layer.

For the quantum dot film and the backlight module of the present invention, quantum rods are disposed in the quantum light-emitting layer, and a dielectric layer and a metal layer having a plurality of metal lines are disposed on the quantum light-emitting layer. Therefore, the quantum rods have a better polarization grade, thereby solving the problems of brightness loss and color deviation caused by using short-wavelength quantum dots to excite long-wavelength quantum dots, and increasing the efficiency of brightness and reducing color deviation.

### BRIEF DESCRIPTION OF THE DRAWINGS

FIG. 1 is a schematic structural diagram showing a quantum dot film in accordance with an embodiment of the present invention.

FIG. 2 is a schematic structural diagram showing a quantum dot film in accordance with another embodiment of the present invention.

FIG. 3 is a schematic structural diagram showing a backlight module in accordance with the present invention.

### DETAILED DESCRIPTION OF THE DISCLOSURE

The following descriptions for the respective embodiments are specific embodiments capable of being implemented for illustrations of the present invention with referring to appending figures. In descripting the present invention, spatially relative terms such as “upper”, “lower”, “front”, “back”, “left”, “right”, “inner”, “outer”, “lateral”, and the like, may be used herein for ease of description as illustrated in the figures. Therefore, the spatially relative terms used herein are intended to illustrate the present invention for ease of understanding, but are not intended to limit the present invention. In the appending drawings, units with similar structures are indicated by the same reference numbers.

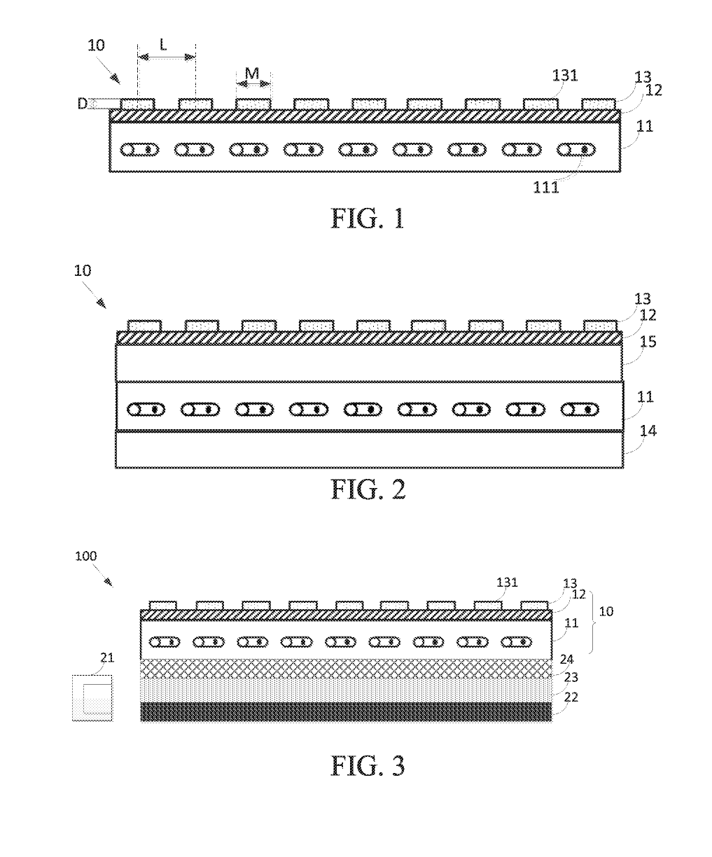

FIG. 1 is a schematic structural diagram showing a quantum dot film in accordance with an embodiment of the present invention.

As shown in FIG. 1, the quantum dot film of the present invention includes a quantum light-emitting layer 11, a dielectric layer 12, a metal layer 13. The quantum light-emitting layer 11 includes a plurality of quantum rods 111 arranged along a same direction. It can be understood that all of the quantum rods 111 are orientated approximately along a same direction. That is, major axes of the quantum rods 111 are distributed approximately along a same direction. The quantum light-emitting layer 11 may further include a resin dielectric layer. The quantum rods 11 are distributed in the resin dielectric layer. Particle sizes of the quantum rods may range from 1 to 10 nanometers. The quantum rods have a better deflection effect in this particle size range, thereby better reducing brightness loss.

The dielectric layer 12 is located on the quantum light-emitting layer 11. The dielectric layer 12 is configured to separate the quantum light-emitting layer 11 from the metal layer 13. The material of the dielectric layer 12 includes at least of SiO₂, SiO, MgO, Si₃N₄, TiO₂, and Ta₂O₅.

The metal layer 13 is located on the dielectric layer 12. The metal layer 13 includes a plurality of metal lines 131 disposed at intervals. The material of the metal layer 13 includes at least of Al, Ag, and Au. These metal lines can make red, green, and blue light better pass through. That is, the light transmittance is increased. The metal lines 131 have a first major axis, which is for example an axis penetrating into the paper, that is, the lengthwise direction of the metal lines 131. The quantum rods 111 have a second major axis, which is for example an axis parallel to the horizontal direction, that is, the lengthwise direction of the quantum rods. An angle between the extending line of the first major axis and the extending line of the second major axis is within a predetermined angular range. Specifically, the lengthwise direction of the metal lines 131 and the lengthwise direction of the quantum rods 111 are not parallel to each other, that is, the predetermined angular range is greater than 0 degree and is less than 180 degrees. It can be understood that fabrication of the metal lines 131 is carried out by patterning whole layer of the metal lines 131.

Blue light emitted from a blue LED (light-emitting diode) in a backlight module enters the quantum light-emitting layer 11 after passing through a light guiding plate. The quantum rods absorb a part of the blue light and are excited to emit red and green light with an excellent degree of polarization. The polarization of the red and blue light is usually parallel to the orientation of the quantum rods and forms a certain angle with the orientation of the metal lines, thereby making the light be able to completely pass through the metal line grid with reflection. The blue light that is not absorbed and its polarization forms a certain angle with the metal lines will pass through the metal lines as well. The polarized light with a direction parallel to the metal lines will be reflected by the metal lines and reenter the quantum light-emitting layer such that the polarized light reacts with the quantum rods, and a part of it enters the light guiding plate and is recycled. The quantum rods have a better polarization grade, thereby solving the problems of brightness loss and color deviation caused by using short-wavelength quantum dots to excite long-wavelength quantum dots, and improving the display effect of the existing display device with extended color gamut.

Preferably, the extending line of the first major axis is approximately perpendicular to the extending line of the second major axis. That is, the lengthwise direction of the metal lines is perpendicular to the lengthwise direction of the quantum rods. When they are perpendicular to each other, the degree of polarization of the quantum rods is optimized, thereby better solving the problems of brightness loss and color deviation caused by using short-wavelength quantum dots to excite long-wavelength quantum dots.

Preferably, the distance L between centers of two adjacent metal lines 131 is ranged from 20 to 500 nanometers. For example, the pitch L between the center of a first metal line 131 at the leftmost side and the center of a second metal line 131 at the leftmost side is ranged from 20 to 500 nanometers. It is not beneficial for the polarization if the pitch of the metal lines extends this range.

Preferably, the ratio of the width of the metal lines 131 to the central pitch L is ranged from 0.1 to 0.9, where the central pitch is a distance between centers of two adjacent metal lines. When the ratio of the width of the metal lines 131 to the pitch of the metal lines 131 is within this range, it can better make the light rays generated from the quantum rods be polarized, thereby improving the utilization of the light rays.

Preferably, the thickness of the metal lines 131 is ranged from 10 to 500 nanometers. It is not beneficial for polarization if the thickness value is too small. It is not beneficial for light transmittance if the thickness value is too large. Therefore, the thickness of the metal lines 131 is set within this range, thereby effectively increasing the light transmittance for ease of light polarization.

Preferably, as shown in FIG. 2, the quantum dot film 10 further includes a first separation layer 14 and a second separation layer 15. The first separation layer 14 is located below the quantum light-emitting layer 11. The second separation layer is located between the quantum light-emitting layer 11 and the dielectric layer 12. The first separation layer 14 and the second separation layer 15 are configured to prevent the quantum light-emitting layer from erosion by water vapor or oxygen molecules.

The fabrication of the quantum light-emitting layer in the quantum dot film includes the following steps.

Step S101: placing a resin dielectric layer having two separation layers arranged top and down into a container, which has a certain number of electrodes transversally disposed thereon, a transversal electric field being generated by applying different bias voltages on the surface of the resin dielectric layer.

Step S102: dripping a solution mixed with a quantum rod ligand uniformly onto the surface of the resin dielectric layer.

Step S103: applying a certain transversal voltage such that the quantum rods are arranged according to the electric field, the transversal voltage being used to generate the transversal electric field.

Step S104: fixing the orientation of the quantum rods by UV (Ultra Violet) radiation or heat curing.

For the quantum dot film of the present invention, quantum rods are disposed in the quantum light-emitting layer, and a dielectric layer and a metal layer having a plurality of metal lines are disposed on the quantum light-emitting layer. Therefore, the quantum rods have a better polarization grade, thereby solving the problems of brightness loss and color deviation caused by using short-wavelength quantum dots to excite long-wavelength quantum dots, and increasing the efficiency of brightness and reducing color deviation.

FIG. 3 is a schematic structural diagram showing a structure of a backlight module in accordance with the present invention.

As shown in FIG. 3, the backlight module 100 includes a light source 21, a reflection plate 22, a light guiding plate 23, an optical film 24, and a quantum dot film 10. The light source 21 is configured to provide original light rays. The light guiding plate 23 is located above the reflection plate 22. The optical film 24 is located above the light guiding plate 23. The quantum dot film 10 is located above the optical film 24.

Specifically, with reference to FIG. 1, the quantum dot film 10 includes a quantum light-emitting layer 11, a dielectric layer 12, a metal layer 13. The quantum light-emitting layer 11 includes a plurality of quantum rods 111 arranged along a same direction. It can be understood that all of the quantum rods 111 are orientated approximately along a same direction. That is, major axes of the quantum rods 111 are distributed approximately along a same direction. The quantum light-emitting layer 11 may further include a resin dielectric layer. The quantum rods 11 are distributed in the resin dielectric layer. Particle sizes of the quantum rods may range from 1 to 10 nanometers. The quantum rods have a better deflection effect in this particle size range, thereby better reducing brightness loss.

The dielectric layer 12 is located on the quantum light-emitting layer 11. The dielectric layer 12 is configured to separate the quantum light-emitting layer 11 from the metal layer 13. The material of the dielectric layer 12 includes at least of SiO₂, SiO, MgO, Si₃N₄, TiO₂, and Ta₂O₅.

The metal layer 13 is located on the dielectric layer 12. The metal layer 13 includes a plurality of metal lines 131 disposed at intervals. The material of the metal layer 13 includes at least of Al, Ag, and Au. These metal lines can make red, green, and blue light better pass through. That is, the light transmittance is increased. The metal lines 131 have a first major axis, which is for example an axis penetrating into the paper, that is, the lengthwise direction of the metal lines 131. The quantum rods 111 have a second major axis, which is for example an axis parallel to the horizontal direction, that is, the lengthwise direction of the quantum rods. An angle between the extending line of the first major axis and the extending line of the second major axis is within a predetermined angular range. Specifically, the lengthwise direction of the metal lines 131 and the lengthwise direction of the quantum rods 111 are not parallel to each other, that is, the predetermined angular range is greater than 0 degree and is less than 180 degrees. It can be understood that fabrication of the metal lines 131 is carried out by patterning whole layer of the metal lines 131.

Preferably, the extending line of the first major axis is approximately perpendicular to the extending line of the second major axis. That is, the lengthwise direction of the metal lines is perpendicular to the lengthwise direction of the quantum rods. When they are perpendicular to each other, the degree of polarization of the quantum rods is optimized, thereby better solving the problems of brightness loss and color deviation caused by using short-wavelength quantum dots to excite long-wavelength quantum dots.

Preferably, the distance L between centers of two adjacent metal lines 131 is ranged from 20 to 500 nanometers. For example, the pitch L between the center of a first metal line 131 at the leftmost side and the center of a second metal line 131 at the leftmost side is ranged from 20 to 500 nanometers. It is not beneficial for the polarization if the pitch of the metal lines extends this range.

Preferably, the ratio of the width of the metal lines 131 to the central pitch L is ranged from 0.1 to 0.9, where the central pitch is a distance between centers of two adjacent metal lines. When the ratio of the width of the metal lines 131 to the pitch of the metal lines 131 is within this range, it can better make the light rays generated from the quantum rods be polarized, thereby improving the utilization of the light rays.

Preferably, the thickness of the metal lines 131 is ranged from 10 to 500 nanometers. It is not beneficial for polarization if the thickness value is too small. It is not beneficial for light transmittance if the thickness value is too large. Therefore, the thickness of the metal lines 131 is set within this range, thereby effectively increasing the light transmittance for ease of light polarization.

Preferably, as shown in FIG. 2, the quantum dot film 10 further includes a first separation layer 14 and a second separation layer 15. The first separation layer 14 is located below the quantum light-emitting layer 11. The second separation layer is located between the quantum light-emitting layer 11 and the dielectric layer 12. The first separation layer 14 and the second separation layer 15 are configured to prevent the quantum light-emitting layer from erosion by water vapor or oxygen molecules.

For the backlight module of the present invention, quantum rods are disposed in the quantum light-emitting layer, and a dielectric layer and a metal layer having a plurality of metal lines are disposed on the quantum light-emitting layer. Therefore, the quantum rods have a better polarization grade, thereby solving the problems of brightness loss and color deviation caused by using short-wavelength quantum dots to excite long-wavelength quantum dots, and increasing the efficiency of brightness and reducing color deviation.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A quantum dot film, comprising:
a quantum light-emitting layer comprising a plurality of quantum rods orientated along a same direction, particle sizes of the quantum rods being ranged from 1 to 10 nanometers;
a dielectric layer located on the quantum light-emitting layer; and
a metal layer located on the dielectric layer, the metal layer comprising a plurality of metal lines disposed at intervals, wherein the metal lines have a first major axis, the quantum rods have a second major axis, and an extending line of the first major axis is substantially perpendicular to an extending line of the second major axis.

2. The quantum dot film according to claim 1, wherein a distance between centers of two adjacent metal lines is ranged from 20 to 500 nanometers.

3. The quantum dot film according to claim 1, wherein a ratio of a width of the metal lines to a central pitch is ranged from 0.1 to 0.9, where the central pitch is a distance between centers of two adjacent metal lines.

4. The quantum dot film according to claim 1, wherein a thickness of the metal lines is ranged from 10 to 500 nanometers.

5. The quantum dot film according to claim 1, wherein a material of the dielectric layer comprises at least of SiO₂, SiO, MgO, Si₃N₄, TiO₂, and Ta₂O₅.

6. The quantum dot film according to claim 1, wherein a material of the metal layer comprises at least of Al, Ag, and Au.

7. The quantum dot film according to claim 1, further comprising a first separation layer and a second separation layer, the first separation layer being located below the quantum light-emitting layer, and the second separation layer being located between the quantum light-emitting layer and the dielectric layer.

8. A backlight module comprising a light guiding plate and a quantum dot film, the quantum dot film comprising:
a quantum light-emitting layer comprising a plurality of quantum rods orientated along a same direction;
a dielectric layer located on the quantum light-emitting layer; and
a metal layer located on the dielectric layer, the metal layer comprising a plurality of metal lines disposed at intervals, wherein the metal lines have a first major axis, the quantum rods have a second major axis, and an angle between an extending line of the first major axis and an extending line of the second major axis is within a predetermined angular range.

9. The backlight module according to claim 8, wherein the extending line of the first major axis is substantially perpendicular to the extending line of the second major axis.

10. The backlight module according to claim 8, wherein particle sizes of the quantum rods are ranged from 1 to 10 nanometers.

11. The backlight module according to claim 8, wherein a distance between centers of two adjacent metal lines is ranged from 20 to 500 nanometers.

12. The backlight module according to claim 8, wherein a ratio of a width of the metal lines to a central pitch is ranged from 0.1 to 0.9, where the central pitch is a distance between centers of two adjacent metal lines.

13. The backlight module according to claim 8, wherein a thickness of the metal lines is ranged from 10 to 500 nanometers.

14. The backlight module according to claim 8, wherein a material of the dielectric layer comprises at least of SiO₂, SiO, MgO, Si₃N₄, TiO₂, and Ta₂O₅.

15. The backlight module according to claim 8, wherein a material of the metal layer comprises at least of Al, Ag, and Au.

16. The backlight module according to claim 8, wherein the quantum dot film further comprises a first separation layer and a second separation layer, the first separation layer is located below the quantum light-emitting layer, and the second separation layer is located between the quantum light-emitting layer and the dielectric layer.
